(19) United States
(12) Patent Application Publication
(10) Pub. No.: US 2013/0242971 A1
(43) Pub. Date: Sep. 19, 2013

(54) SYSTEMS AND METHODS FOR DATA COMMUNICATIONS USING SOFT-DECISION AND SUPPORT VECTOR MACHINES

(71) Applicant: AUCKLAND UNISERVICES LIMITED, Auckland (NZ)

(72) Inventors: Stevan Berber, Auckland (NZ); Vojislav Kecman, Auckland (NZ); Johnny Wei-Hsun Kao, Auckland (NZ)

(73) Assignee: AUCKLAND UNISERVICES LIMITED, Auckland (NZ)

(21) Appl. No.: 13/795,642

(22) Filed: Mar. 12, 2013

(30) Foreign Application Priority Data
Mar. 13, 2012 (NZ) 598742

(51) Int. Cl. H04B 1/7103

(52) U.S. Cl. CPC H04B 1/7103
USPC 370/342

(57) ABSTRACT

Described herein are systems and methods for receiving coded data signals in a code division multiple access (CDMA) communication system. A method of one embodiment of the invention includes, at step (100), formulating a decision function which estimates a transmitted data signal from a received noisy coded data signal. At step (102), a transmitted CDMA signal is received. The CDMA signal includes a plurality of multiplexed coded data signals from multiple users. At step (104), the CDMA signal is demultiplexed to extract and decode the coded data signals based on the decision function such that interference between the users is substantially reduced. Finally, at step (106), the receiver outputs a plurality of decoded data signals, each corresponding to a single user.

### FIELD OF THE INVENTION

The present invention relates to systems and methods for receiving data in a code division multiple access (CDMA) telecommunications system.

Embodiments of the invention have been particularly developed as an improved CDMA receiver capable of reducing multi-access interference. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

As the multitude of services and applications provided by the mobile telephony industry have increased rapidly over the last decade, it also urges the need to develop a robust multi-user system which can accommodate more active user to access the common channel on the same time. The code division multiple access (CDMA) has gained wide attention and popularity due to its ability to allow multiple users to communicate on the same time over a wide frequency band. It has been applied in various wireless networks including 3G cellular networks.

However, the primary concern of such system, like many other random sequences, is the imperfect orthogonality of the sequences would causes interference. This problem of multi-access interference (MAI) is worsened when more users are transmitting or when the interferers are sufficiently powerful at the receiver's side to cause performance degradation. This is one of the main bottle-necks of this system. To mitigate this phenomenon, a variety of multi-user detection (MUD) methods have been proposed. Some examples of currently popular detectors are de-correlating detector, minimum mean square error (MMSE) detector, and interference cancellation detectors. However, because they all require some vital information from all the active users, it is widely known that these methods cannot be applied in down-link, where these information are difficult to retrieve. A single-user (i.e., blind) detector itself is a challenging problem.

Furthermore, in most modern communication systems, channel coding (or also referred as error control coding) is commonly employed to further reduce the transmission errors. At the transmitter, a channel encoder is used to protect the transmitted data by adding some controlled redundancy into the data stream. When the data stream is transmitted through the wireless channel, the original data is likely to be corrupted due to noise and other undesired interferences from the surroundings. On the receiver, the channel decoder can discover and correct some of the errors from the corrupted data-stream, in order to recover the original message. For the channel decoder, it is able to perform error correction based on two types of inputs. The first type is referred to as hard decision decoding, where decoder is limited to only binary inputs (i.e., for example, +1 to represent a logic 1 and −1 to represent logic 0). The second type is referred as soft decision decoding, where the input to the decoder is within a range of real values (i.e., multi-level inputs). Obviously, a soft decision decoder would outperform a hard decision one because the decoder has more information about the received signal. However, most of the MUD methods do not address this issue and only provide the estimation in hard outputs. Consequently, the full potential of the decoder cannot be realized under such limitations of the existing MUD methods.

### SUMMARY OF THE INVENTION

It is an object of the present invention to overcome or ameliorate at least one of the disadvantages of the prior art, or to provide a useful alternative.

According to a first aspect of the present invention there is provided a method of receiving coded data signals in a code division multiple access (CDMA) communication system, said method including the steps of:

formulating a decision function which estimates a transmitted data signal from a received noisy coded data signal;

receiving a transmitted CDMA signal including a plurality of multiplexed coded data signals from multiple users;

demultiplexing said CDMA signal to extract and decode said coded data signals based on said decision function such that interference between said users is substantially reduced; and

outputting a plurality of decoded data signals, each corresponding to a single user.

The decoded data is preferably output in a non-binary soft-decision format thereby allowing soft-decision error decoding of the data signals.

The step of formulating the decision function preferably includes performing the initial calibration steps of:

receiving one or more test signals;

identifying a separation plane which maximises the spreading of the test signals; and

generating the decision function based on the identified separation plane.

The decision function is preferably represented as a series of coefficients, each adapted to operate on the CDMA signal to decode an individual coded signal.

According to a second aspect of the present invention there is provided a computer system including a processor configured to perform a method according to the first aspect described above.

According to a third aspect of the present invention there is provided a computer program product configured to perform a method according to the first aspect described above.

According to a fourth aspect of the present invention there is provided a computer readable medium carrying a set of instructions that when executed by one or more processors cause the one or more processors to perform a method according to the first aspect described above.

According to a fifth aspect of the present invention there is provided a code division multiple access (CDMA) receiver including:

an input port for receiving a transmitted CDMA signal including a plurality of multiplexed coded data signals from multiple users;

a support vector machine adapted to:
formulate a decision function which estimates a transmitted data signal from a received noisy coded data signal; and
demultiplex said CDMA signal to extract and decode said coded data signals based on said decision function such that interference between said users is substantially reduced:

a plurality of output ports, each adapted for outputting a decoded data signal corresponding to a single user.

The CDMA receiver of the fifth aspect described above preferably further includes:

a decoder downstream of the support vector machine for error decoding each coded data signal for error correction; and

wherein the support vector machine provides non-binary soft-decision inputs to the decoder thereby allowing soft-decision decoding of the data signals.

To formulate the decision function, the support vector machine preferably performs an initial calibration procedure including the steps of:
receiving one or more test signals;
identifying a separation plane which maximises the spreading of the test signals; and
generating the decision function based on the identified separation plane.

The support vector machine preferably represents the decision function as a series of coefficients, each adapted to operate on the CDMA signal to decode an individual coded signal.

According to a sixth aspect of the present invention there is provided a CDMA communication system incorporating a CDMA receiver according to the fifth aspect described above.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 is a block diagram illustrating the steps performed by the method according to one embodiment of the present invention:

FIG. 2 is a schematic representation of a CDMA transmitter in a typical direct sequence code division multiple access (DS-CDMA) system;

FIG. 3a is a schematic representation of a prior art correlator receiver;

FIG. 3b is a schematic representation of a prior art minimum mean square error (MMSE) detector:

FIG. 3c is a schematic representation of a support vector machine CDMA receiver according to one embodiment of the invention;

FIG. 4 is a schematic representation one embodiment of the present invention during the training phase of operation;

FIG. 5 is a schematic representation of the present invention during the implementation phase of operation; and

FIG. 6 is a plot of the bit error rate as a function of signal-to-noise ratio of a prior art correlator receiver, MMSE detector and a support vector machine CDMA receiver according to one embodiment of the invention.

### DETAILED DESCRIPTION

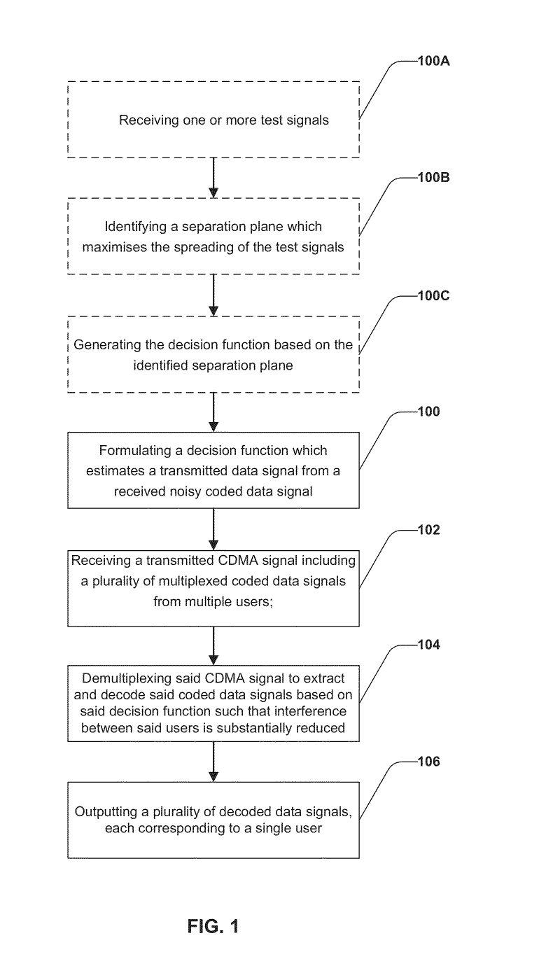

Described herein are systems and methods for receiving coded data signals in a code division multiple access (CDMA) communication system. Referring initially to FIG. 1, a method of one embodiment of the invention includes, at step 100, formulating a decision function which estimates a transmitted data signal from a received noisy coded data signal. At step 102, a transmitted CDMA signal is received. The CDMA signal includes a plurality of multiplexed coded data signals from multiple users. At step 104, the CDMA signal is demultiplexed to extract and decode the coded data signals based on the decision function such that interference between the users is substantially reduced. Finally, at step 106, the receiver outputs a plurality of decoded data signals, each corresponding to a single user.

In one embodiment the decision function is formulated by performing an initial calibration procedure in a so-called “training phase”. This procedure includes, at step 100A, receiving one or more test signals, at step 100B, identifying a separation plane which maximises the spreading of the test signals, and, at step 100C, generating the decision function based on the identified separation plane.

### System Model

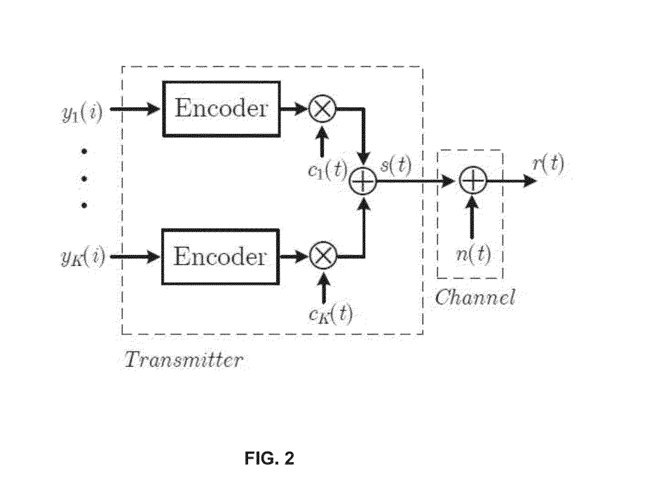

FIG. 2 shows a schematic diagram of a transmitter in a typical direct sequence code division multiple access (DS-CDMA) system. Assuming there are a total k number of users in the system, trying to send a message simultaneously across its intended receiver, where yₖ(i)ε{1,0} denotes the binary symbol for the k^{th} user. The information is first encoded by a channel encoder and spread by a unique pseudo-random sequence denoted by cₖ(t), and cₖ(t)={c_{k,1}, c_{k,2}, . . . , c_{k,2β}}, where 2β represents the length of sequence to spread one encoded bit (this parameter is also known as the spreading factor of the system). Each chip within the sequence, denoted by c_{k,t}, can be binary or non-binary. The transmitted signal at the output of the transmitter, denoted by s(t), is a summation from every user's spread signal. The transmitted signal is corrupted at the wireless channel by noise and other undesirable interferences (denoted by n(t)). The received signal (denoted by r(t)) is the direct combination of the transmitted signal, s(t), and the channel noise n(t).

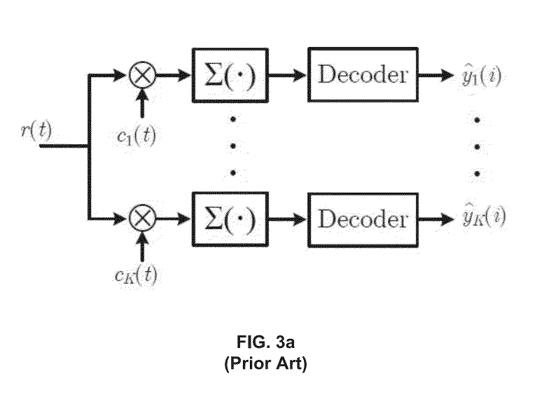

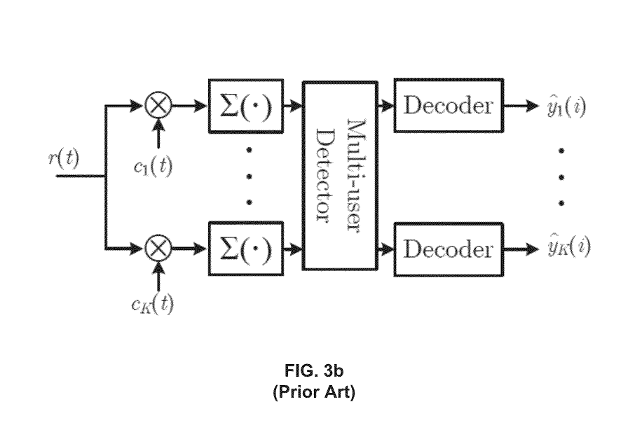

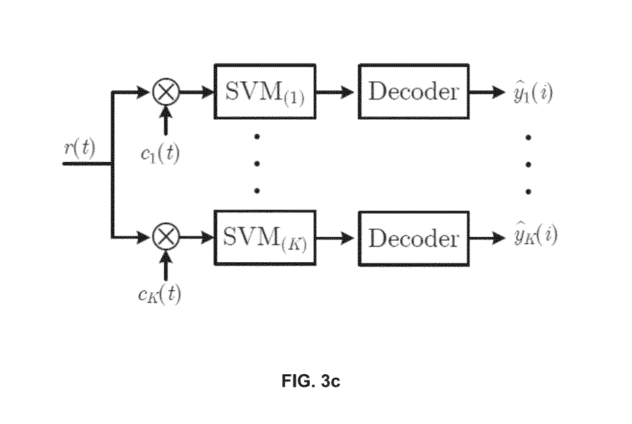

FIG. 3 illustrates two different types of prior art receiver structure (FIGS. 3a and 3b), and the presently disclosed support vector machine (SVM) receiver (FIG. 3c). The simplest prior art correlator receiver is shown in FIG. 3a. Since the correlator receiver cannot mitigate the inherent multi-access interference (MAT) within the system, even use of a channel decoder would only help to decrease the bit error rate up to a limited extent. This becomes a limitation on the accuracy of the estimated symbol, yₖ(i). In order to combat this problem, a muhi-user detector (MUD) has been developed. A conventional prior art MUD is typically attached downstream of the bank of correlators, as shown in FIG. 3b. However, these existing methods have two major drawbacks. Firstly, as depicted in FIG. 3b, the MUD operation requires all of the users' spreading codes, which is not practically feasible in the down-link (i.e., the transmission from base-station to mobile users). Secondly, the output from the conventional MUD is only in hard decision, meaning it is limited to fixed binary inputs.

FIG. 3c illustrates the receiver of one embodiment of the present invention. This implements a SVM receiver which does not have any of the constraints mentioned above. It can operate independently, and thus can be implemented in both down-link and up-link (i.e., mobile user to base-station). Most importantly, it can provide soft decision inputs to a channel decoder, meaning error correction codes with higher greater than two values (binary code) can be implemented.

### Support Vector Machine

The present invention incorporates a support vector machine (SVM) in the receiver, which is able to act as an intelligent multi-user detector, mitigating or at least reducing the multi-access interference experienced by conventional CDMA receivers. SVM is a machine learning technique which originates from the theory of statistical analysis and soft computing. It has successful applications in the field of pattern recognition and data mining.

In the present invention the SVM has two stages of operations: the initial training or the learning stage, which is only required to be performed once in the beginning of the operation, unless the underlying parameters such as the total number of users or the spreading factor have been changed significantly; and the actual implementation stage in which real data is transmitted and the estimation of the transmitted symbols or data sequences from noisy signals actually takes place.

During the training stage, the main goal of a SVM is to identify a separation (hyper) plane which maximizes the margin between the two datasets of {+1} and {−1} in a high dimensional space. Identification of this separation plane allows a decision function to be formulated. Since the SVM does not need to know about other user's spreading sequences during training or testing, it can be regarded as ‘semi-blind’ or a ‘single-user’ detection method.

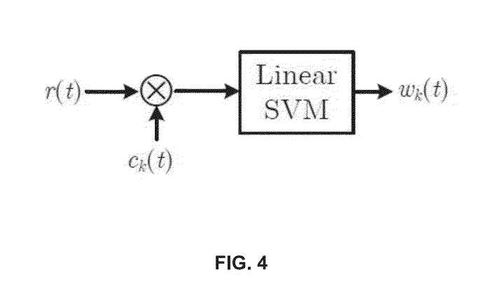

It has been shown in the literature that, for this application, the simplest linear SVM can produce a similar result to that of other types of SVM having a more sophisticated kernel. As a result of using a linear SVM, the decision function can be alternatively expressed by a series of coefficients through some simple mathematical manipulation. This form can significantly reduce complexity of the receiver during implementation. FIG. 4 shows a model of the SVM receiver during the training phase of operation. For the k^{th} user, the input to the receiver is the received signal after despreading by its spreading sequence. After collecting some training data, the linear SVM can produce the coefficients wₖ(t)={w_{k,1}, . . . , w_{k,2β}}, which has a combined effect of despreading and multi-user detection.

The complexity of SVM receiver of the present invention is vastly different to that of conventional receivers such as the correlator receiver of FIG. 3a. The complexity is completely controlled by the number of support vectors (related to the coefficients wₖ(t)) and the length of codeword to be processed. In contrast, the conventional algorithms depend heavily on the structure of the encoder. Therefore, as the number of memory elements increases in the encoder, the decoding complexity for many conventional receivers increases exponentially. This is a major drawback of those techniques for applications such as deep space communication where the order of memory can reach to 10 or more. However, this would not have any effect on the present invention provided the length of each codeword remains the same. The independency of encoder structure becomes another advantage for the SVM receiver. While the present invention can only process a given N bits at a time, there is capability for multiple SVM receivers to be employed in parallel to increase the decoding speed.

In one embodiment, the input of the SVM demodulator in the training stage is a set of received data streams from 1 number of message bits. The i^{th} training data stream with n number of sample points can be represented by x, ={x, x₂, . . . x}, which is the received signal for one message bit and has been multiplied by an interpolated spreading signal. The multiplication in this stage is applied in order to decorrelate or separate the information from each other user. Hence information from other users becomes noise-like for the desired user. Each data stream has an associated message of what was sent. Therefore, in this embodiment, the whole dataset can be represented as (x₁y₁), (x₂y₂), . . . (xₗyₗ), where x₁ε [symbol] ⁿ, i=1, . . . , l and y₁ε{+1, . . . , −1}, which represents the desired output result.

During the training phase, a decision function is formed by the SVM model. This decision function is used to estimate the transmitted symbol from the unknown noisy signal. As previously mentioned, the decision function can be re-arranged into a series of coefficients so that the complexity during testing is comparable to the simplest correlator receiver.

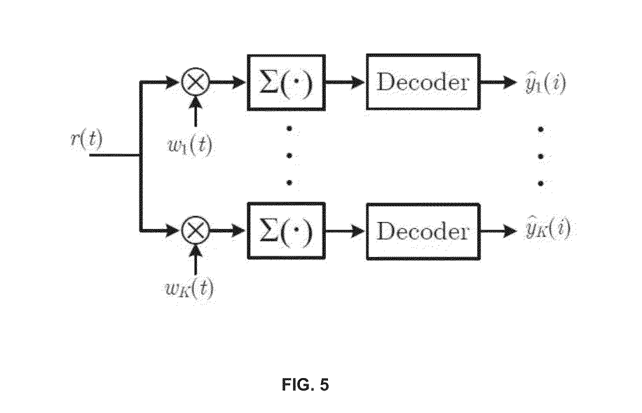

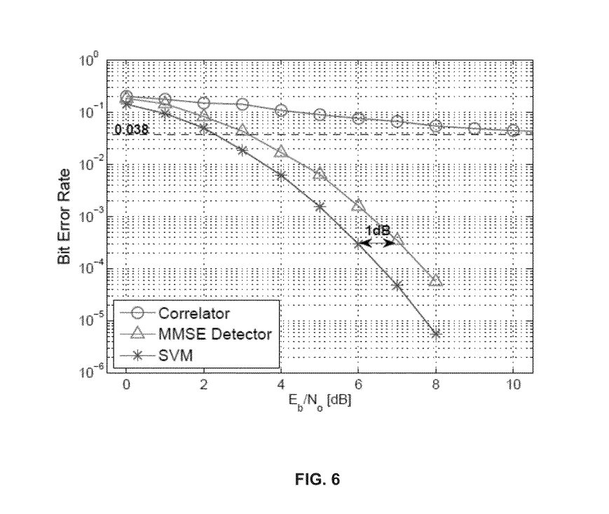

FIG. 5 shows a schematic diagram of the SVM receiver during the implementation stage. The receiver is similar to the correlator receiver shown in FIG. 3a, but the spreading codes c(t) has been replaced by the SVM coefficients w(t). Therefore although both receiver structures have similar complexity, the SVM receiver or the present invention significantly outperforms the correlator receiver, as shown in FIG. 6 and outlined in the example below.

After completing the training phase, the SVM demodulator is ready for estimating the source bit based on classifying the transmitted and received CDMA data stream that has been multiplied with the interpolated spreading sequence. The task of demodulation or demultiplexing then becomes essentially a pattern classification problem. The transmitted message bit is estimated by making a soft-decision or a hard-decision from the decision function formed in the training phase.

In conventional SVM applications, a threshold value of 0 is placed on the output of the SVM in order to estimate the original class that the unknown object belongs to. In the present invention, the actual output is retained for soft decision decoding by the channel decoder. The re-use of the soft information from the output of the SVM is an important and advantageous aspect of the present invention.

### Example Implementation of the Invention

As an example to illustrate the performance of the proposed invention, a simulator of a DS-CDMA system which uses non-binary chaotic spreading sequences was designed. The system has 4 users and a spreading factor of 20. A rate ½ convolutional encoder was used at encoding and a standard soft-decision Viterbi decoder was used to decode the received signal from the output of the receiver. The channel consisted of only additive white Gaussian noise (AWGN) with a uniform power spectral density of N₀/2. A key indicator on the reliability of the system is its bit error rate (BER), which is the probability that a transmitted bit will be in error. In essence, a lower BER is always more desirable than a higher one.

FIG. 5 graphs the BER comparisons of the two prior art receivers illustrated in FIGS. 2a and 2b with that of the present invention illustrated in FIG. 2c. Firstly, the correlator receiver (of FIG. 2a) would experience an error floor where the BER cannot reduce below 0.038. This phenomenon is due to the inability to mitigate the multi-access interference inherent in the transmitted signal. As signal-to-noise ratio (in terms of the E_{b}=N₀ ratio) increases, the BER from the present invention (SVM receiver) is significantly lower than that of the correlator receiver, because of its multi-access detection ability. This performance improvement also suggests the power saving capability from the present invention. For instance, if the application requires a BER of 0.04, a correlator receiver would need to increase the transmitter power so that the receiver is at E_{b}=N₀ of 10 dB or more. For the present invention, it would only require E_{b}=N₀ of 2 dB. In this case, the transmitter can save about 84% of power if the receiver is switched from a correlator to the SVM receiver of the present invention, while still achieving the same performance.

Secondly, when comparing the SVM receiver of the present invention with the state-of-the-art minimum mean square error (MMSE) detector (FIG. 2b), the present invention still has a coding gain of about 1 dB because of the advantage of soft-decision over hard-decision decoding. As previously mentioned, the MMSE detector requires every user's spreading sequence, which is also impractical in real down-link systems.

Furthermore, a numerical example is used here to compare the reliability of the three receivers: if 100,000 bits are sent at E_{b}=N₀ of 6 dB, a conventional correlator receiver would result in approximately 7,600 errors after decoding; the MMSE receiver would have 160 errors; and finally the SVM receiver of the present invention would reduce the number of errors down to approximately 30. Such a significant improvement in the transmission reliability is due to the multi-access interference mitigation and the soft-decision decoding capability of the present invention, which is not present in other receivers.

### CONCLUSIONS

It will be appreciated that the disclosure above provides a novel support vector machine (SVM) based CDMA receiver is proposed in this patent, which is a single-user detector that can mitigate multi-access interference, and is also able to provide soft decision for further decoding. SVM is a machine learning approach that originated from statistical learning theory, and it is immensely popular and highly recognized in the fields of data-mining and pattern classification.

It will also be appreciated that the CDMA receiver according to the invention can be retro-fitted into existing CDMA communication systems.

Advantages of the above-described invention include:
The SVM receiver can mitigate the multi-access interference in the system. Hence it allows the overall capacity of the system to be increased and can provide a higher data-rate service to the end-users.
The receiver can operate independently, which means it does not require other user's information. Therefore it is capable of operating in the down-link (i.e., base-station to mobile user). The receiver is also compatible with existing CDMA transmitters.
The receiver is adapted to provide soft-decision for enhancing the performance of error control coding. This can result in a further reduction in transmission errors, thereby improving the reliability of the system.
The present invention is more energy conservative in that the transmitting power required to satisfy the performance margin can be reduced. As a result, the proposed receiver can reduce the link-budget of the system and extend the over life-time of the transceiver by saving both transmitter and receiver power.
The reliability of service of the receiver can be adjusted through unequal error protection of the receiver.
The complexity is similar to the simplest conventional correlator receiver.

Unless specifically stated otherwise, as apparent from the following discussions, it is appreciated that throughout the specification discussions utilizing terms such as “processing,” “formulating”, “generating”, “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data. e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g. software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected. e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

While only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is indicated in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; a carrier wave bearing a propagated signal detectable by at least one processor of the one or more processors and representing the set of instructions a propagated signal and representing the set of instructions: and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks.

Steps may be added or deleted to methods described within the scope of the present invention.

The claims defining the invention are as follows:

1. A method of receiving coded data signals in a code division multiple access (CDMA) communication system, said method including the steps of:
formulating a decision function which estimates a transmitted data signal from a received noisy coded data signal;
receiving a transmitted CDMA signal including a plurality of multiplexed coded data signals from multiple users;
demultiplexing said CDMA signal to extract and decode said coded data signals based on said decision function such that interference between said users is substantially reduced; and
outputting a plurality of decoded data signals, each corresponding to a single user.

2. A method according to claim 1 wherein said decoded data is output in a non-binary soft-decision format thereby allowing soft-decision error decoding of said data signals.

3. A method according to claim 1 or claim 2 wherein the step of formulating said decision function includes performing the initial calibration steps of:
receiving one or more test signals;
identifying a separation plane which maximises the spreading of said test signals; and
generating said decision function based on said identified separation plane.

4. A method according to claim 1 or claim 2 wherein said decision function is represented as a series of coefficients, each adapted to operate on said CDMA signal to decode an individual coded signal.

5. A method substantially as herein described with reference to any one of the embodiments of the invention illustrated in FIG. 1, 3C, 4, 5 or 6, and/or the accompanying examples.

6. A computer system including a processor configured to perform a method according to any one of the preceding claims.

7. A computer program product configured to perform a method according to any one of the preceding claims.

8. A computer readable medium carrying a set of instructions that when executed by one or more processors cause the one or more processors to perform a method according to any one of the preceding claims.

9. A code division multiple access (CDMA) receiver including:
an input port for receiving a transmitted CDMA signal including a plurality of multiplexed coded data signals from multiple users;
a support vector machine adapted to:
formulate a decision function which estimates a transmitted data signal from a received noisy coded data signal; and
demultiplex said CDMA signal to extract and decode said coded data signals based on said decision function such that interference between said users is substantially reduced;
a plurality of output ports, each adapted for outputting a decoded data signal corresponding to a single user.

10. A CDMA receiver according to claim 9 further including:
a decoder downstream of said support vector machine for error decoding each said coded data signal for error correction; and
wherein said support vector machine provides non-binary soft-decision inputs to said decoder thereby allowing soft-decision decoding of said data signals.

11. A CDMA receiver according to claim 10 wherein, to formulate said decision function, said support vector machine performs an initial calibration procedure including the steps of:
receiving one or more test signals;
identifying a separation plane which maximises the spreading of said test signals; and
generating said decision function based on said identified separation plane.

12. A CDMA receiver according to any one of claims 9 to 11 wherein said support vector machine represents said decision function as a series of coefficients, each adapted to operate on said CDMA signal to decode an individual coded signal.

13. A CDMA receiver substantially as herein described with reference to any one of the embodiments of the invention illustrated in FIG. 1, 3C, 4, 5 or 6, and/or the accompanying examples.

14. A CDMA communication system incorporating a CDMA receiver according to any one of claims 9 to 13.
